(19) United States
(12) Patent Application Publication
(10) Pub. No.: US 2012/0089959 A1
(43) Pub. Date: Apr. 12, 2012

(54) METHOD AND APPARATUS FOR CREATING SERVICE FLOW BASED ON USER'S GOAL-DRIVEN SEMANTIC SERVICE DISCOVERY

(75) Inventor: Yoo Mi PARK, Daejeon (KR)

(73) Assignee: ELECTRONICS AND TELECOMMUNICATIONS RESEARCH INSTITUTE, Daejeon (KR)

(21) Appl. No.: 13/025,932

(22) Filed: Feb. 11, 2011

(30) Foreign Application Priority Data
Oct. 11, 2010 (KR) 10-2010-0098742

(51) Int. Cl. G06F 15/16

(52) U.S. Cl. 717/105

(57) ABSTRACT

Provided is a method and apparatus for automatically creating a service flow. A goal may be identified based on a keyword input from a user. The identified goal may be decomposed into at least one sub-goal, and a service may be discovered and determined with respect to each sub-goal. A service flow may be created based on the determined service, and a code may be generated based on the service flow.

### CROSS-REFERENCE TO RELATED APPLICATION

This application claims the benefit of Korean Patent Application No. 10-2010-0098742, filed on Oct. 11, 2010, in the Korean Intellectual Property Office, the disclosure of which is incorporated herein by reference.

### BACKGROUND

1. Field of the Invention

Embodiments of the present invention relate to a method and apparatus for automatically creating a service flow, and more particularly, to a method and apparatus for automatically creating a service flow by semantically discovering an appropriate web service according to a declarative goal of a requestor.

2. Description of the Related Art

A task of developing a software application using a Service-Oriented Architecture (SOA) based web service highly depends on experiences or technology levels of developers.

Currently, many researches on SOA based web service technology have been conducted in service search, i.e., discovery and service composition fields. In particular, in the service composition field, technology about dynamic service composition and automatic service composition has been studied.

In the dynamic service composition, a service to be bound in the case of execution of a service may be determined.

In the automatic service composition, a service may be automatically composed in design or execution of the service without intervention of a developer.

The existing dynamic service composition and automatic service composition are generally focused on technology of matching types of input and output parameters of a service to be composed, and technology of converting a protocol between a service provider and a user.

In order to dynamically and automatically compose a service, towards which goal, for example, a user request, the service is to be composed may become an issue. Accordingly, implicitly assuming the user request may be inappropriate.

When a goal of an application that a user wants to develop is accurately verified and the verified goal of the application is semantically utilized, a quality of a dynamically and automatically composed service may be improved.

### SUMMARY

According to an aspect of the present invention, there is provided an apparatus for providing a web service flow, the apparatus including: a goal analyzer to analyze and identify a user's goal based on a keyword; and a goal driven discovery to discover at least one service that is determined based on the identified user's goal, and to create a service flow based on the discovered at least one service. In this invention, a typical user may be a software developer or programmer.

The web service flow providing apparatus may further include a user interface control to receive the keyword from the user, to display at least one sub-goal corresponding to the given keyword, and to recognize a sub-goal selected by the user from the at least one sub-goal.

The web service flow providing apparatus may further include a goal ontology including at least one word and a semantic relationship between words. The goal analyzer may identify the user's goal based on the keyword by discovering a synonym of the keyword from the goal ontology.

The web service flow providing apparatus may further include a goal pattern library to store a relationship pattern between the goal and the at least one sub-goal. After the goal analyzer may identify the user's goal based on the keyword, it looks up at least one candidate goal associated with the discovered synonym from the goal pattern library,

The goal driven discovery may decompose the identified user's goal into at least one sub-goal, and may discovers web services satisfying each of the at least one sub-goal.

The web service flow providing apparatus may further include a goal pattern library to store a relationship pattern between the goal and the at least one sub-goal. The goal driven discovery may decompose the identified user's goal into the at least one sub-goal using the relationship pattern.

The relationship may correspond to an ordered list of the at least one sub-goal constituting the goal.

The services may satisfy each of the at least one sub-goal and non-functional properties.

The web service flow providing apparatus may further include a service registry to store a list of services and a list of information associated with each service. The goal driven discovery may create the service flow based on at least one discovered service by discovering, from the service registry, services satisfying each of the at least one sub-goal.

The web service flow providing apparatus may further include a code generator to generate a code in programming language or XML based on the created service flow.

The code generator may generate the code based on the created service flow by sequentially converting, to a source code, a call and a control of the at least one sub-goal included in the service flow.

The code may correspond to at least one of a source code and an intermediate code.

According to another aspect of the present invention, there is provided an interface providing apparatus for creating a web service flow, the interface providing apparatus including: a goal editor to display at least one sub-goal associated with a keyword input from a user, and to recognize a goal selected by the user from the at least one sub-goal; a flow editor to display a service corresponding to the goal and a service flow satisfying the goal, and to edit the service flow; and a code viewer to view and edit a source code that is generated based on the edited service flow, and to edit the source code.

The interface providing apparatus may further include a goal viewer to display at least one discovered service corresponding to the selected goal. The service corresponding to the goal may correspond to one of the at least one discovered service.

The goal editor may recognize non-functional properties selected by the user. The service may correspond to the non-functional properties and the service flow may satisfy the to non-functional properties.

The flow editor may provide a function of modification of service flow and a function of extracting a discoveredservice that is chosen by a user.

The source code may correspond to at least one of an Extensible Markup Language (XML) code and a programming language code.

According to still another aspect of the present invention, there is provided a method of providing a web service flow, the method including: identifying a goal and non-functional properties based on a keyword; discovering a web service based on the identified goal and non-functional properties; creating a service flow corresponding to the discovered web service; and generating a code corresponding to the service flow.

According to embodiments of the present invention, there may be provided a method and apparatus for analyzing a goal input from a developer and semantically discovering a web service suitable for the analyzed goal.

According to embodiments of the present invention, there may be provided a method and apparatus for automatically creating a service flow of web services discovered for the analyzed goal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a web service flow providing apparatus according to an embodiment of the present invention;

FIG. 2 is a diagram illustrating an interface for creating a web service flow according to an embodiment of the present invention;

FIG. 3 is a diagram to describe a process of creating a service flow according to an embodiment of the present invention;

FIG. 4 is a diagram illustrating syntax of {execution sequence of sub-goals} for creating a service flow defined as Abstract Syntax Notation. 1 (ASN.1) according to an embodiment of the present invention;

FIG. 5 is a diagram illustrating a source code generated from a service flow according to an embodiment of the present invention;

FIG. 6 is a diagram illustrating total use cases of an automatic service flow creation system through a user goal driven semantic web service discovery according to an embodiment of the present invention;

FIG. 7 is a flowchart of UC1_CreatApp use case of FIG. 6 according to an embodiment of the present invention;

FIG. 8 is a flowchart of UC11_BuildGoal use case of FIG. 6 according to an embodiment of the present invention;

FIG. 9 is a flowchart of UC12_DiscoverSvc use case of FIG. 6 according to an embodiment of the present invention;

FIG. 10 is a flowchart of UC13_MakeFlow use case of FIG. 6 according to an embodiment of the present invention; and

FIG. 11 is a flowchart of UC14_GenerateCode use case of FIG. 6 according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are to described below to explain the present invention by referring to the figures.

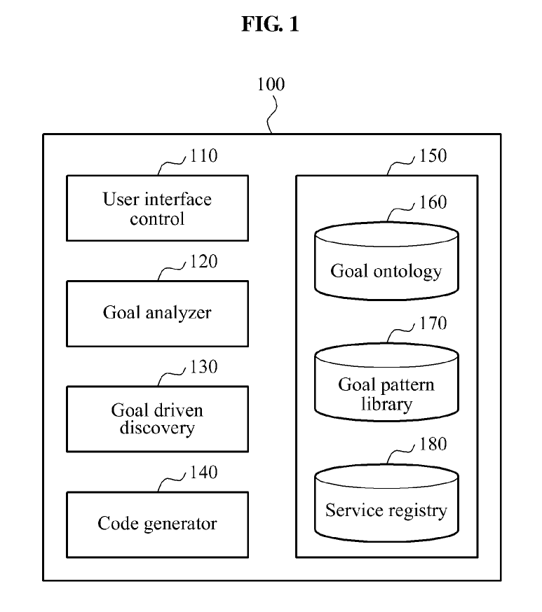

FIG. 1 is a block diagram illustrating a configuration of a web service flow providing apparatus 100 according to an embodiment of the present invention.

The web service flow providing apparatus 100 may automatically create a service flow through a user goal driven semantic web service discovery.

The web service flow providing apparatus 100 may be an application creator functional block (AppCreatorFB) to create a web service flow and to generate a code according to the web service flow.

The web service flow providing apparatus 100 may include a user interface control 110, a goal analyzer 120, a goal driven discovery 130, a code generator 140, and a storage 150.

The storage 150 may include a goal ontology or a terminology ontology 160, a goal pattern library 170, and a service registry 180.

The goal ontology 160 may include at least one word and a relationship between words. The goal ontology 160 may include a domain-specific ontology and a common ontology.

The goal pattern library 170 may store a relationship between a goal and at least one sub-goal. The relationship between the goal and the at least one sub-goal indicates an ordered list of the at least one sub-goal constituting the goal. When a basic service flow is created, a service sequence may be determined based on the ordered list. A relationship pattern may be pre-configured for each service area.

Specifically, the goal pattern library 170 may store data designed as “<goal, {execution sequence of sub-goals}>”, and may store information indicating a method of extracting {execution sequence of sub-goals} from the goal.

The service registry 180 may store a list of services and a list of information associated with each service. The service registry 180 may store functional properties and non-functional properties of the service.

The user interface control 110 may be a set of user interface functions that perform a connecting functionality between the web service flow providing apparatus 100 and a user.

The user interface control 110 may provide an interface for automatically creating a service flow through a user goal driven semantic web service discovery.

The user may operate other constituent elements, for example, the goal analyzer 120, the goal driven discovery 130, and the code generator 140 using the user interface control 110.

The user interface control 110 may receive a keyword from the user and display at least one sub-goal corresponding to the received keyword. When the user selects a predetermined sub-goal from the displayed at least one sub-goal, the user interface control 110 may recognize the selected sub-goal.

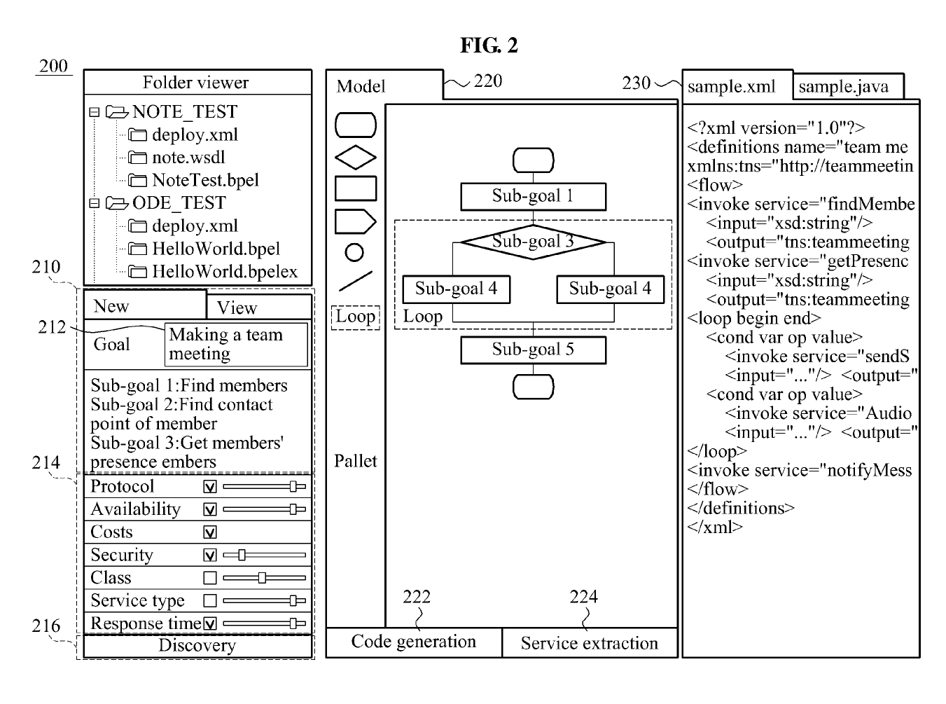

A configuration of the user interface control 110 will be further described with reference to FIG. 2.

The goal analyzer 120 may identifier a goal intended by the user based on the keyword input from the user.

The goal analyzer 120 may receive the input keyword from the user interface control 110.

The goal analyzer 120 may analyze the received keyword and discover a synonym of the keyword. The goal analyzer 120 may discover the synonym from the goal ontology 160. Here, at least one synonym may be discovered.

The goal analyzer 120 may discover, from the goal pattern library 170, at least one candidate goal associated with the discovered synonym.

The goal analyzer 120 may provide the at least one candidate goal to the user interface control 110. The user interface control 110 may display candidate goals and identifier a candidate goal selected by the user from the candidate goals. The selected candidate goal that is identified by the user interface control 110 may be determined as the to goal intended by the user.

The goal driven discovery 130 may discover at least one service corresponding to the identified goal, and may create a service flow based on the discovered at least one service.

The service flow may be created based on an execution sequence of sub-goals designated in <goal, {execution sequence of sub-goals}> from the goal pattern library 170.

The goal driven discovery 130 may decompose the identified goal into at least one sub-goal, and may discover services satisfying each of the at least one sub-goal. Here, a sub-goal may be a condition for discovering a functional semantic of a web service.

The goal driven discovery 130 may decompose the identified goal into at least one sub-goal based on a relationship pattern stored in the goal pattern library 170.

The goal driven discovery 130 may discover, from the service registry 180, services satisfying at least one sub-goal. With respect to each of the at least one sub-goal, the goal driven discovery 130 may semantically discover, from the service registry 180, services satisfying a corresponding sub-goal (that is, a functional semantic) and non-functional properties.

The code generator 140 may generate a code based on the created service flow. The code generator 140 may sequentially convert, to a source code, a call and a control of at least one sub-goal displayed on the service flow to generate the code. The call may include a parallel execution and a sequential execution, and the control may include an iteration and a selection.

The generated code may be at least one of a source code and an intermediate code. At least one of a JAVA code for a JAVA native application and a JAVA server pages (JSP) code for a JAVA web application may be selected.

The generated code may be included in another application and may be used to create an application.

FIG. 2 is a diagram illustrating an interface for creating a web service flow according to an embodiment of the present invention.

An interface 200 may be provided by the user interface control 110 of FIG. 1.

The interface 200 may include a goal editor 210, a flow editor 220, and a code viewer 230.

The goal editor 210 may provide a keyword input portion 212. A user may input a keyword into the keyword input portion 212.

The goal editor 210 may display at least one sub-goal associated with the keyword input from the user. The user may select a single sub-goal from the displayed at least one sub-goal, and the goal editor 210 may recognize the selected sub-goal.

The goal editor 210 may perform multiple processing. For example, the goal editor 210 may perform discovery with respect to a plurality of goals at a one time.

The goal editor 210 may provide a non-function property designation portion 214. The user may designate a non-function property condition with respect to a service discovery by manipulating the non-function property designation portion 214. Non-function properties may be limited to an available range during a service annotation. The goal editor 210 may recognize the non-function property selected by the user.

The goal editor 210 may provide a service discovery button 216. The user may discover a service satisfying a selected goal including a functional property, and the non-functional properties by manipulating the service discovery button 216, for example, by clicking on the service discovery button 216.

The flow editor 220 may display the service corresponding to the selected goal and a basic service flow satisfying the selected goal.

The flow editor 220 may provide an edition function with respect to the basic service flow. The user may edit the basic service flow using a Drag&Drop and the like.

The flow editor 220 may include a source code generation menu 222 for requesting a source code generation with respect to the service flow.

The flow editor 220 may provide a function of extracting a determined service that is generated by editing the service flow. For example, the user may extract only the determined service by manipulating a service extraction menu 224.

The code viewer 230 may display the source code that is generated based on the edited service flow and the service, and provide an edition function with respect to the code.

The code viewer 230 may provide the same or similar functionality to a general source code editor.

The source code may be an Extensible Markup Language (XML) code or a programming language code such as JAVA.

The interface 200 may further include a goal viewer (not shown) to display at least one discovered service corresponding to the selected goal. A service corresponding to the goal may be one of the at least one discovered service.

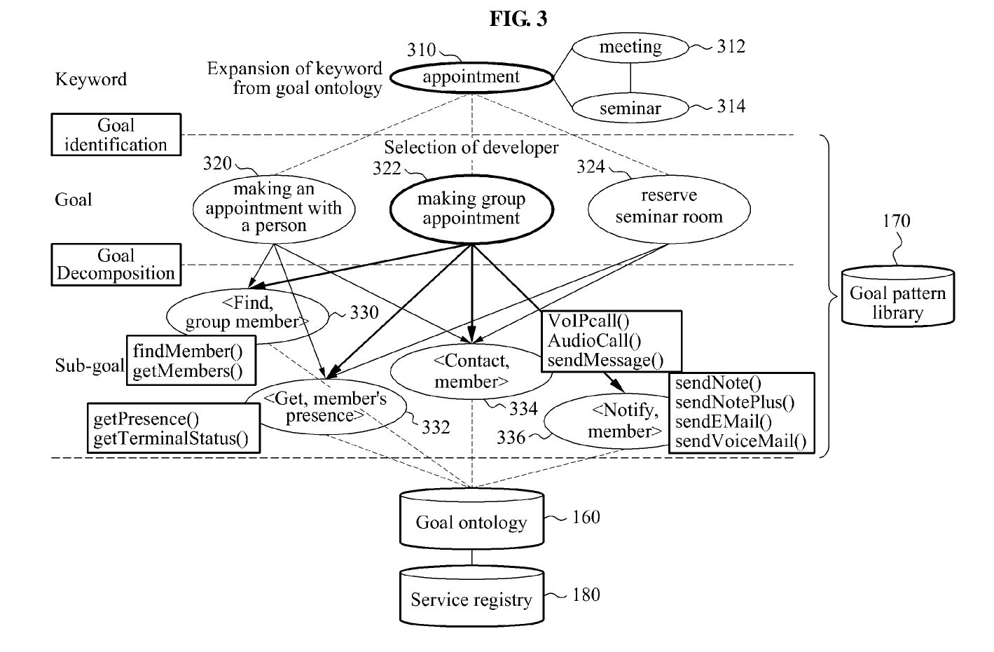

FIG. 3 is a diagram to describe a process of creating a service flow according to an embodiment of the present invention.

During the above process, the goal analyzer 120 and the goal driven discovery 130 may employ, as major components, the goal ontology 160, the goal pattern library 170, and the service registry 180 that are included in the storage 150.

When a keyword input from a user is “appointment” 310, “meeting” 312 and “seminar” 314 may be obtained as synonyms of “appointment” 310 through the goal ontology 160. Accordingly, a goal that may be induced using the keyword “appointment” 310 and the synonyms “meeting” 312, and “seminar” 314 may be discovered.

As a discovery result, “making an appointment with a person” 320, “making group appointment” 322, and “reserve seminar room” 324 that are text based goals may be obtained.

The above discovered goals 320, 322, and 324 may be displayed for a developer. The developer may select one of the goals 320, 322, and 324. In this instance, the developer may clearly verify a goal of the keyword.

When the developer selects the goal “making group appointment” 322, sub-goals satisfying “making group appointment” 322 may be discovered from the goal pattern library 170. In this instance, an execution sequence of the sub-goals may also be extracted. A service flow may be automatically created by using the extracted execution sequence.

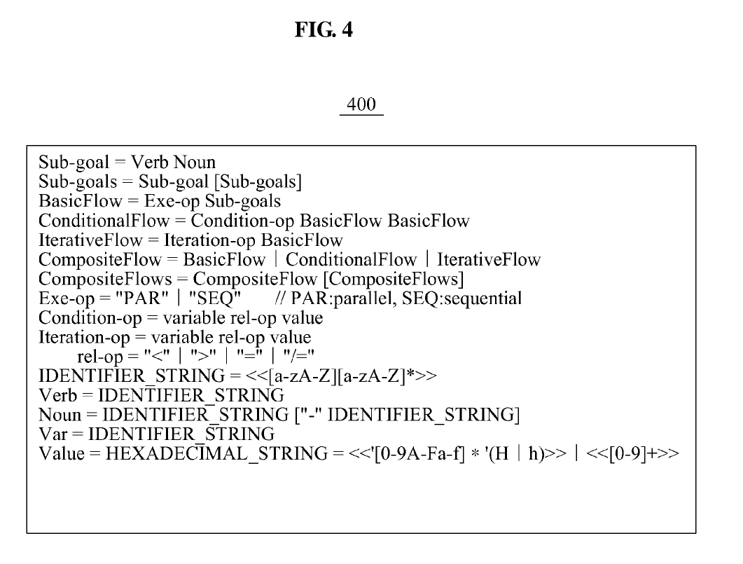

Syntax of {execution sequence of sub-goals} for creating the service flow will be further described with reference to FIG. 4.

In the present example, {execution sequence of sub-goals} of the selected goal “making group appointment” 322 may be expressed by “SEQ {<Find group-member> 330, <Get member's-presence> 332, <Contact member> 334, <Notify Member> 336}”. The service flow may be created to sequentially call the above sub-goals.

The created service flow may be corrected and edited by the developer, for example, using the flow editor 220. During the correction and edition process, the developer may select one of discovered web services satisfying the selected sub-goal. In FIG. 3, at least one web service corresponding to a sub-goal indicated as a circular shape is displayed within an adjacent rectangular box.

For example, the developer may select “AudioCall( )” that is one of web services corresponding to the sub-goal “<Contact member>” 334.

FIG. 4 is a diagram illustrating syntax of {execution sequence of sub-goals} for creating a service flow defined as Abstract Syntax Notation. 1 (ASN.1) according to an embodiment of the present invention.

ASN.1 corresponds to a data notation standard adopted in a computer communication field and may specify a data expression and conversion, for example, encoding and decoding, standard, and the like.

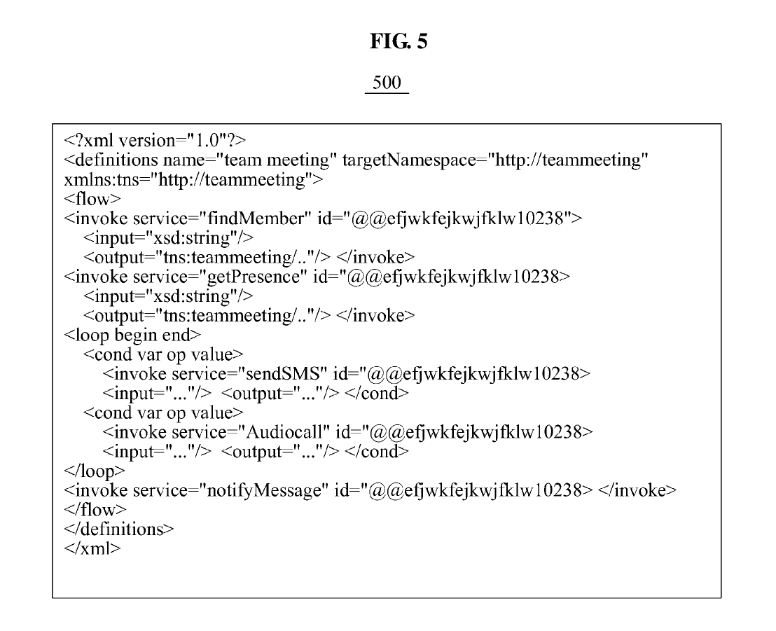

FIG. 5 is a diagram illustrating a source code generated from a service flow according to an embodiment of the present invention.

An XML code may be directly generated form an automatically generated goal to pattern. In general, an automatically generated code may have a state in which an intention of a developer is not fully completed.

To clearly reflect the intent of the developer in the service flow, the developer may directly edit and store the automatically created service flow, and may generate a code from the edited service flow.

A tag for generating the XML code from tasks of the service flow may be defined and mapped as given by Table 1.

TABLE 1

Service flow → <flow>
Service call → <invoke service>
Service input and output → <input > <output>
Conditional statement → <cond>
Iterative statement → <loop>

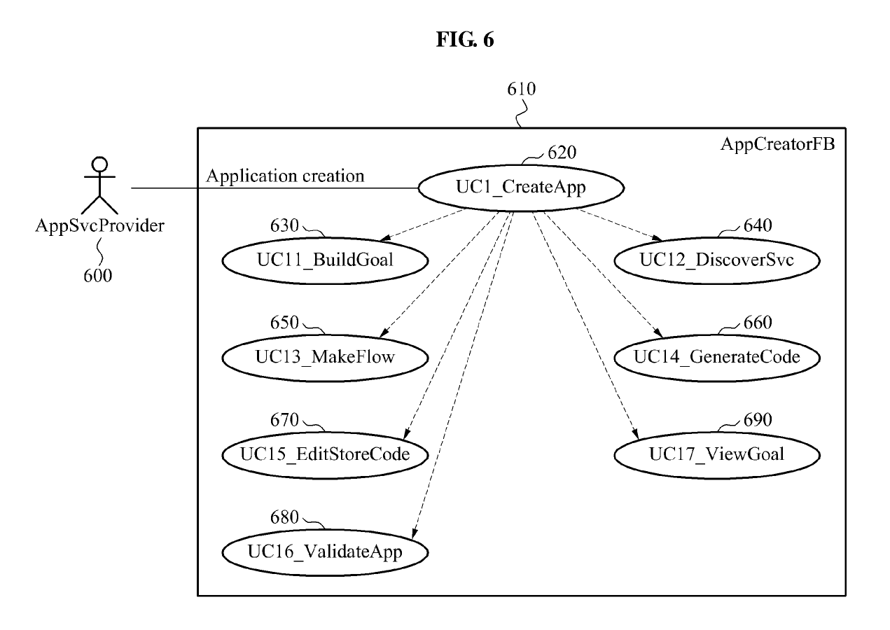

FIG. 6 is a diagram illustrating total use cases of an automatic service flow creation system through a user goal driven semantic web service discovery according to an embodiment of the present invention.

In FIG. 6, a dotted line denotes “<<include>>” relationship. Each of circles 620, 630, 640, 650, 660, 670, 680, and 690 denotes a use case.

An Application Service Provider (AppSvcProvider) 600 corresponds to a main actor and denotes a developer.

An Application Creator Functional Block (AppCreatorFB) 610 may include the use cases 620, 630, 640, 650, 660, 670, 680, and 690 for creating an application.

The AppSvcProvider 600 may develop an application using the AppCreatorFB 610.

The AppSvcProvider 600 may build a goal using UC11_BuildGoal of the use case 630.

The AppSvcProvider 600 may discover a service satisfying the goal using UC12_DiscoverSvc of the use case 640. UC12_DiscoverSvc may provide the discovered service.

The AppSvcProvider 600 may create a service flow including discovered services using UC13_MakeFlow of the use case 650.

The AppSvcProvider 600 may generate a source code from the created service flow using UC14_GenerateCode of the use case 660.

The AppSvcProvider 600 may edit the generated source code using UC15_EditStoreCode of the use case 670.

The AppSvcProvider 600 may verify the edited code using UC16_ValidateApp of the use case 680.

The AppSvcProvider 600 may display, in a tree structure, a goal and sub-goals discovered so far, and services satisfying the same using UC17_ViewGoal of the use case 690.

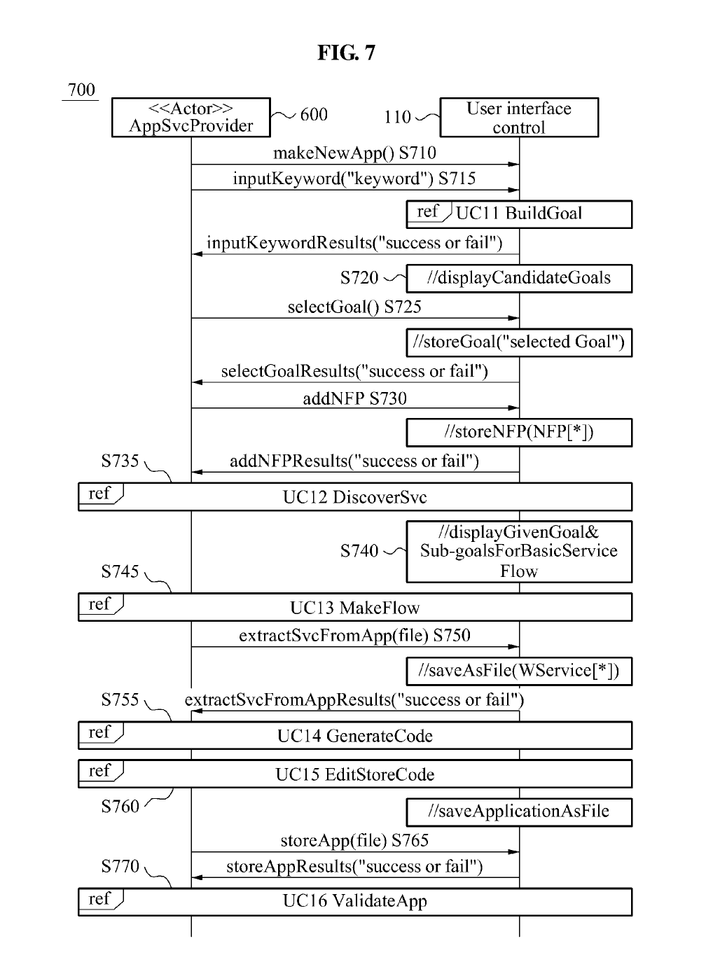

FIG. 7 is a flowchart of UC1_CreatApp of the use case 620 of FIG. 6 according to an embodiment of the present invention.

In FIG. 7, the AppSvcProvider 600 and the user interface control 110 indicate entities that may perform operation S710 through operation S770.

In operation S710, a user may execute the AppCreatorFB 610 in order to create an application, and a user window may be popped up.

In operation S715, a single word of a keyword indicating the user's intent may be input.

In operation S720, candidate goals inducible from the input keyword may be displayed for the user.

In operation S725, the user may select, from the displayed candidate goals, a goal expressed closet to the user's intent.

In operation S730, non-functional properties of a service may be selected and be designated as a condition of a service discovery together with the selected goal.

In operation S735, a service may be discovered based on the goal and the non-functional properties.

In operation S740, a basic service flow may be created based on the discovery results, for example, a list of sub-goals and a list of services satisfying each of the sub-goals, and may be displayed for the user.

In operation S745, the user may complete the service flow by editing the basic service flow and selecting a predetermined service for each sub-goal.

In operation S750, only service information may be extracted from the completed service flow.

In operation S755, a source code may be generated.

In operation S760, the generated source code may be edited and may also be pasted to another application.

In operation S765, the application may be stored as a file.

In operation S770, syntax may be verified by compiling the application.

Technical description according to an embodiment of the present invention described above with reference to FIG. 1 through FIG. 6 may be applicable to the present embodiment. Accordingly, further detailed description will be omitted here.

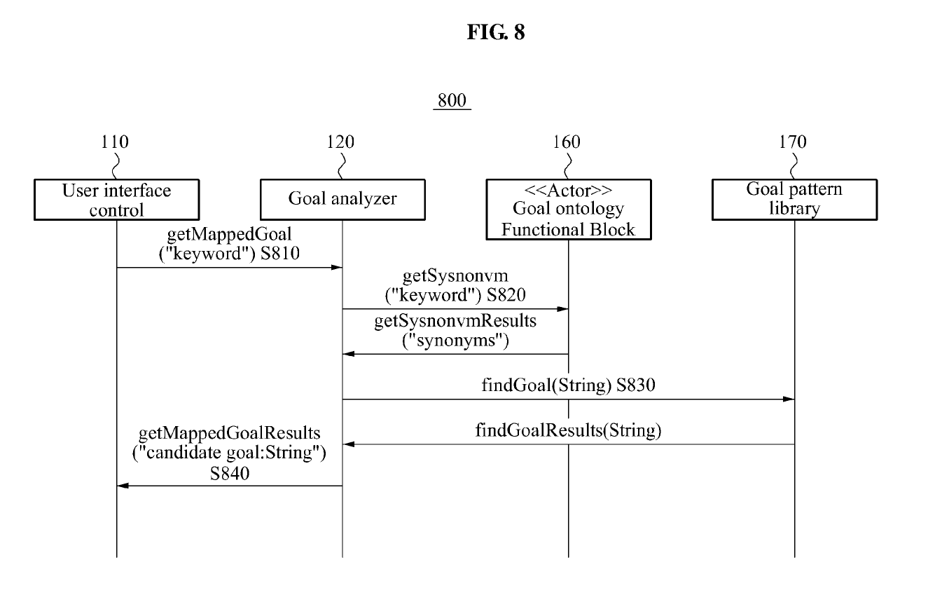

FIG. 8 is a flowchart of UC11_BuildGoal of the use case 630 of FIG. 6 according to an embodiment of the present invention.

In FIG. 8, the user interface control 110, the goal analyzer 120, the goal ontology 160, and the goal pattern library 170 indicate entities that may perform operation S810 through operation S840.

In operation S810, a keyword input from a user may be transferred from the user interface control 110 to the goal analyzer 120.

In operation S820, the goal analyzer 120 may acquire synonyms of the keyword by requesting the goal ontology functional block.

In operation S830, the goal analyzer 120 may search the goal pattern library 170 to obtain a goal associated with the keyword expanded through the synonyms.

In operation S840, the user interface control 110 may display discovered goals for the user as candidate goals.

Technical description according to an embodiment of the present invention described above with reference to FIG. 1 through FIG. 7 may be applicable to the present embodiment. Accordingly, further detailed description will be omitted here.

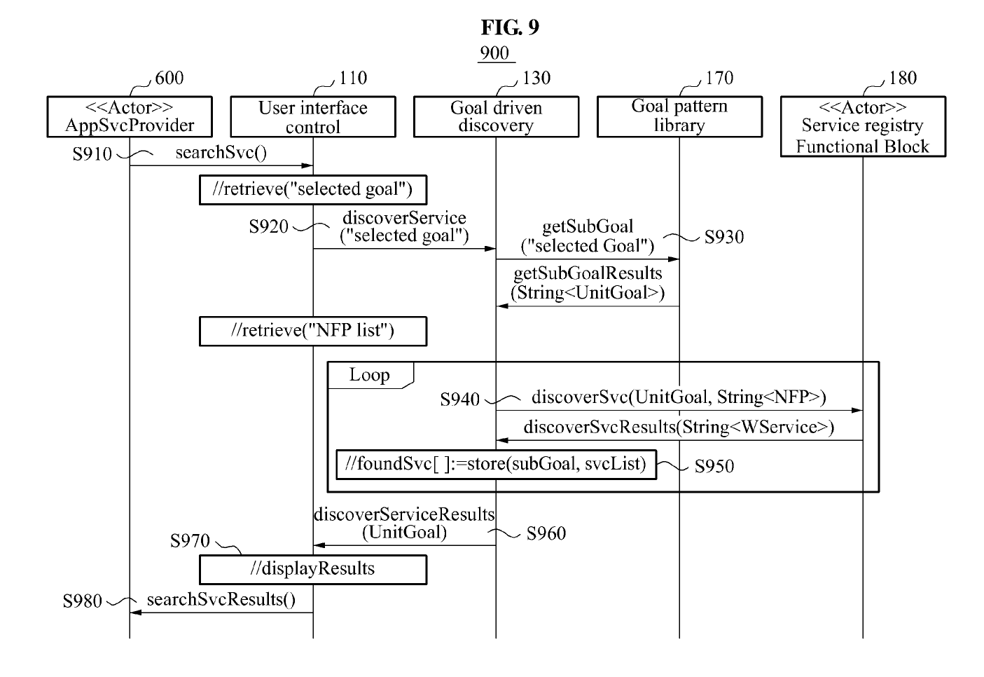

FIG. 9 is a flowchart of UC12_DiscoverSvc of the use case 640 of FIG. 6 according to an embodiment of the present invention.

In FIG. 9, the AppSvcProvider 600, the user interface control 110, the goal driven discovery 130, the goal pattern library 170, and the service registry 180 indicate entities that may perform operation S910 through operation S980.

In operation S910, a user may press a discovery button provided by the user interface control 110 to discover a service satisfying a goal and non-functional properties selected by the user. Specifically, the user interface control 110 may receive a request by means of the AppSvcProvider 600.

In operation 5920, the user interface control 110 may transfer, to the goal driven discovery 130, information for discovering the service satisfying the selected goal and non-functional properties, and may request the goal driven discovery 130 for a service discovery.

In operation 5930, the goal driven discovery 130 may request the goal pattern library 170 to decompose the goal into at least one sub-goal.

In operation 5940, the goal driven discovery 130 may request the service registry 180 to discover a service satisfying non-functional properties for each sub-goal.

In operation 5950, the goal driven discovery 130 may store the discovered service.

Operations 5940 and 5950 may be repeated by a loop until no sub-goal remains.

In operation 5960, when the goal driven discovery 130 returns the discovered service, the user interface control 110 may output the discovery results to the flow editor 220 using a picture.

In operation 5970, the discovery results may be displayed as a text by the user interface control 110.

In operation 5980, the discovery results may be returned to the AppSvcProvider 600 by the user interface control 110.

Technical description according to an embodiment of the present invention described above with reference to FIG. 1 through FIG. 8 may be applicable to the present embodiment. Accordingly, further detailed description will be omitted here.

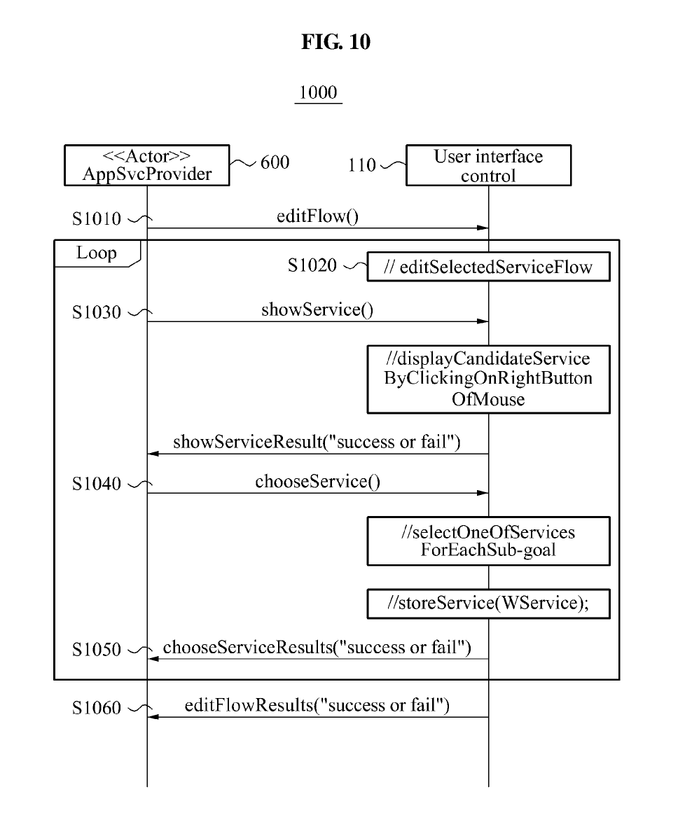

FIG. 10 is a flowchart of UC13_MakeFlow of the use case 650 of FIG. 6 according to an embodiment of the present invention.

In FIG. 10, the AppSvcProvider 600 and the user interface control 110 indicate entities that may perform operation S1010 through operation S1060.

In operation S1010, the AppSvcProvider 600 may move to a window popped up by the flow editor 220 to edit a basic service flow displayed after a service discovery.

In operation S1020, graphic icons in a pallet may be used to edit the service flow using a Drag&Drop.

In operation 51030, the AppSvcProvider 600 may verify services satisfying a sub-goal by clicking on a right button of a mouse and the like.

In operation S1040, a service to be actually invoked, that is, called may be selected for each sub-goal.

In operation 51050, the selected service may be stored.

Operations S1020 through S1050 may be repeated until no sub-goal remains.

In operation 51060, a flow edition may be terminated.

Technical description according to an embodiment of the present invention described above with reference to FIG. 1 through FIG. 9 may be applicable to the present embodiment. Accordingly, further detailed description will be omitted here.

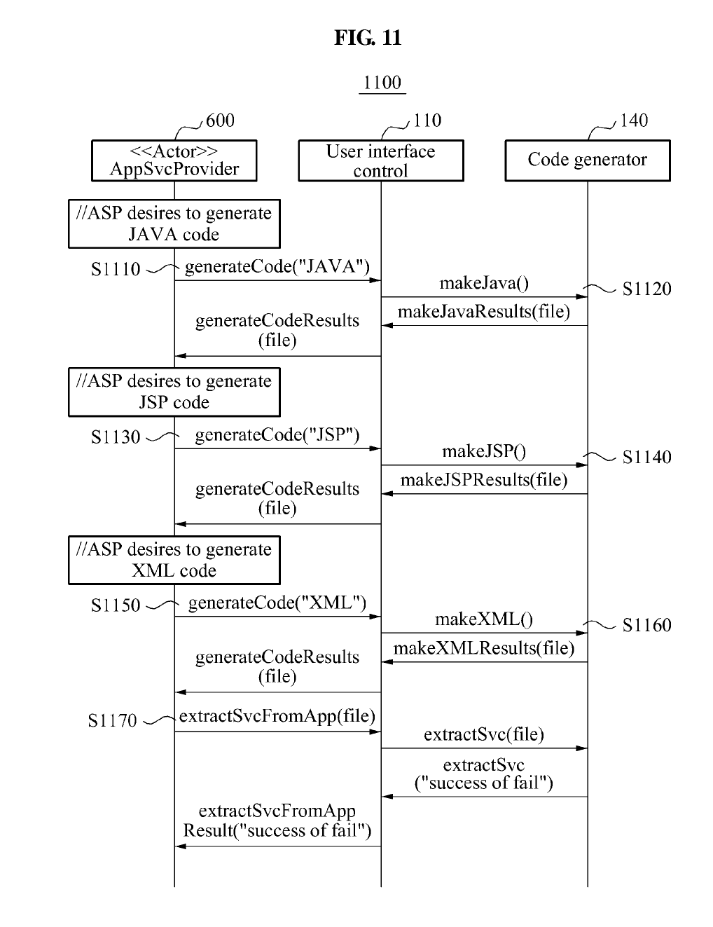

FIG. 11 is a flowchart of UC14_GenerateCode of the use case 660 of FIG. 6 according to an embodiment of the present invention.

In FIG. 11, the AppSvcProvider 600, the user interface control 110, and the code generator 140 indicate entities that may perform operation S1110 through operation S1170.

In operation S1110, when a service flow is completed, the AppSvcProvider 600 may request the user interface control 110 to generate a JAVA code.

In operation S1120, the user interface control 110 may request the code generator 140 to generate the JAVA code and the request results may be stored as a file.

In operation S1130, when the service flow is completed, the AppSvcProvider 600 may request the user interface control 110 to generate a JSP code.

In operation S1140, the user interface control 110 may request the code generator 140 to generate the JSP code and the request results may be stored as a file.

In operation S1150, when the service flow is completed, the AppSvcProvider 600 may request the user interface control 110 to generate an XML code.

In operation S1160, the user interface control 110 may request the code generator 140 to generate the XML code and the request results may be stored as a file.

In operation S1170, the AppSvcProvider 600 may request the code generator 140 to extract a service from the XML code by means of the user interface control 110, and the request results may be stored as a file.

Technical description according to an embodiment of the present invention described above with reference to FIG. 1 through FIG. 10 may be applicable to the present embodiment. Accordingly, further detailed description will be omitted here.

According to the aforementioned embodiments, a developer may quickly search many web services for a web service suitable for the developer's goal. The developer may shorten a development period by developing an application through composition of discovered web services. Even a general user not a web service expert may generate a source code by utilizing a service flow provided according to the embodiments. That is, even a user not an expert skilled in a programming language or a web service may easily develop a composed web service application.

According to the aforementioned embodiments, it is possible to improve a goal accuracy by providing a procedure for verifying an intent of a developer. In addition, a semantic discovery may be enabled with respect to web services by adding a functional/non-functional semantic. Accordingly, a high level of service flow satisfying a goal may be obtained.

According to the aforementioned embodiments, an application including a composition of web services may be developed by inputting and selecting only a development goal of the application. Accordingly, an automatically created service flow may be enhanced and total development costs including a development procedure, a time, and the like may be reduced.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, to such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for providing a web service flow, the apparatus comprising:
a goal analyzer to analyze and identify a user's goal based on a keyword; and
a goal driven discovery to discover at least one service that is determined based on the identified user's goal, and to create a service flow based on the discovered at least one service.

2. The apparatus of claim 1, further comprising:
a user interface control to receive the keyword from the user, to display at least one sub-goal corresponding to the received keyword, and to recognize a sub-goal selected by the user from the at least one sub-goal.

3. The apparatus of claim 1, further comprising:
a goal ontology comprising at least one word and a relationship between words,
wherein the goal analyzer identifies the user's goal based on the keyword by discovering a synonym of the keyword from the goal ontology.

4. The apparatus of claim 3, further comprising:
a goal pattern library to store a relationship pattern between the goal and the at least one sub-goal,
wherein the goal analyzer identifies the user's goal based on the keyword by discovering, from the goal pattern library, at least one candidate goal associated with the discovered synonym.

5. The apparatus of claim 1, wherein the goal driven discovery decomposes the identified user's goal into at least one sub-goal, and discovers services satisfying each of the at least one sub-goal.

6. The apparatus of claim 5, further comprising:
a goal pattern library to store a relationship pattern between the goal and the at least one sub-goal,
wherein the goal driven discovery decomposes the identified user's goal into the at least one sub-goal using the relationship pattern.

7. The apparatus of claim 6, wherein the relationship corresponds to an ordered to list of the at least one sub-goal constituting the goal.

8. The apparatus of claim 5, wherein the services satisfy each of the at least one sub-goal and non-functional properties.

9. The apparatus of claim 1, further comprising:
a code generator to generate a code based on the created service flow.

10. The apparatus of claim 9, wherein the code generator generates the code based on the created service flow by sequentially converting, to a source code, a call and a control of the at least one sub-goal included in the service flow.

11. The apparatus of claim 9, wherein the code corresponds to at least one of a source code and an intermediate code.

12. An interface providing apparatus for creating a web service flow, the interface providing apparatus comprising:
a goal editor to display at least one sub-goal associated with a keyword input from a user, and to recognize a goal selected by the user from the at least one sub-goal;
a flow editor to display a service corresponding to the goal and a service flow satisfying the goal, and to edit the service flow; and
a code viewer to display a source code that is generated based on the edited service flow, and to edit the source code.

13. The interface providing apparatus of claim 12, further comprising:
a goal viewer to display at least one discovered service corresponding to the selected to goal,
wherein the service corresponding to the goal corresponds to one of the at least one discovered service.

14. The interface providing apparatus of claim 12, wherein:
the goal editor recognizes non-functional properties selected by the user, and
the service corresponds to the non-functional properties and the service flow satisfies the non-functional properties.

15. The interface providing apparatus of claim 12, wherein the flow editor provides a function of extracting a determined service that is created by editing the service flow.

16. The interface providing apparatus of claim 12, wherein the source code corresponds to at least one of an Extensible Markup Language (XML) code and a programming language code.

17. A method of providing a web service flow, the method comprising:
identifying a goal based on a keyword and non-functional properties selected by user;
discovering a web service based on the identified goal and non-functional properties;
creating a service flow corresponding to the discovered web services; and
generating a code corresponding to the service flow.
